(19) United States
(12) Patent Application Publication
(10) Pub. No.: US 2007/0220451 A1
(43) Pub. Date: Sep. 20, 2007

(54) Method for modeling and documenting a network

(75) Inventors: Joseph A. Arnone, Phoenix, AZ (US); William E. Fleming, Surprise, AZ (US); Christopher J. Rael, Phoenix, AZ (US)

Correspondence Address: MESCHKOW & GRESHAM, P.L.C., 5727 NORTH SEVENTH STREET, SUITE 409, PHOENIX, AZ, 85014, US

(73) Assignee: Arizona Public Service Company

(21) Appl. No.: 11/378,441

(22) Filed: Mar. 16, 2006

(51) Int. Cl. G06F 17/50

(52) U.S. Cl. 716/1

(57) ABSTRACT

A network documentation system computer program (302) for documenting a network (100) receives a configuration of elements (205) within the network (100). Methodology (320) of the program represents the elements (205) by nodes (336) in a model of the network (100). Each of the nodes (336) is defined by one of a plurality of nodes types (402), and each of the node types (402) governs structure rules (504) for child nodes (808) and connectivity rules (508) for defining links (338) between nodes (336). The nodes (336) are presented in a network graph (312) in accordance with the structure rules (504) to document the network (100), with the child nodes (808) associated with their respective parent nodes (806). The links (338) are depicted between the nodes (336) in the network graph (312) in accordance with the connectivity rules (508), and represent connections between pairs of elements (205) in the network (100).

### TECHNICAL FIELD OF THE INVENTION

The present invention relates to the field of networks. More specifically, the present invention relates to a network management system for documenting a network.

### BACKGROUND OF THE INVENTION

Complex networks, such as telecommunications networks, enterprise networks, and the like, typically include one or more types of specialized components that interconnect on various levels. Such networks have grown to become complex, heterogeneous environments spanning multiple locations and platforms. As networks have grown ever more complex, simple hand drawn sketches and spreadsheets have become inadequate for thorough documentation of such networks. That is, such networks are far too vast, varied, and complex to be understood completely without comprehensive documentation. Consequently, automated mechanisms for modeling, documenting, and managing the networks have emerged. These mechanisms are generally implemented in the form of computer programs, typically referred to as network management systems.

Network documentation is required by many individuals in an organization. For example, operations staff needs up to date information to run the network. Planning staff needs to know what has been installed and what is in the process of being installed. Implementation staff needs to know where they can pick up the existing network to connect a new network extension. Sales staff needs to know the reach, capability, and capacity of the network to maximize their sales efforts, and, of course, service staff needs to understand the network configuration in order to make repairs.

Typically, data models used in network management systems for tracking the elements of network systems have been structured to track known configuration information within one type of network. Furthermore, various organizations have developed their own data models, with the result being repetition of many of the same activities and a collection of many non-compatible data models. Many data models are so radically different that, even though the same information may be required by, and embedded in, multiple models, variations in the form and organization of that information within the disparate models makes it extremely difficult to move from one system to another, or to compare the information for consistency from one system to another. The net result is a collection of prior art systems that operate in a stand-alone fashion, without the benefit of the wealth of information contained in other related systems.

Additionally, such data models often cannot support the introduction of new technologies into their data structures. Thus, with existing modeling techniques, new databases or complex extensions to existing databases are required to support new communication technologies or application specific information. The result is a series of disjointed databases with appended tables, all of which cannot be operated, managed, or understood by a single individual. Consequently, a large team of people and resources may be needed to model, track, and document network configuration information and interdependencies between the network elements.

Therefore, what is needed is a network documentation technique that enables a user to readily model and document the elements of a complex network and to model and document relationships between the elements within the network. What is also needed is a network documentation technique that is readily extendible to support new communication technologies, interdependencies between network elements, and application specific information. Network complexity necessitates documentation that is sharable and available to those who are responsible for maintaining the network. Consequently, what is further needed is a network documentation technique in which network information is recorded, consolidated, and standardized in a form that can be made readily available throughout an organization.

### SUMMARY OF THE INVENTION

Accordingly, it is an advantage of the present invention that a computer-based method and a computer program are provided for documenting a network.

It is another advantage of the present invention that a computer-based method and computer program are provided that model and document network elements and relationships in a common format.

Another advantage of the present invention is that a computer-based method and executable code are provided that allow for straightforward extension of a network model and network documentation.

The above and other advantages of the present invention are carried out in one form by a computer-based method for documenting a network. The method calls for receiving a configuration of elements within the network and representing the elements by nodes in a model of the network, each of the nodes being defined by one of a plurality of node types, and each of the node types governing structure rules for descendable ones of the nodes. The nodes are presented in a network graph in accordance with the structure rules to document the network.

The above and other advantages of the present invention are carried out in another form by a computer-readable storage medium containing a computer program for documenting a network. The computer program includes a library of node types constructed in accordance with a node type template. The node type template includes a structure rule field for entry of structure rules, the structure rules identifying descendable ones of the node types. The computer program further includes executable code for instructing a processor to create a network graph, the executable code instructing the processor to perform operations including receiving a configuration of elements within the network and representing the elements by nodes in a model of the network. The representing operation calls for selecting, for each of the nodes, a node type defining the node from the library of node types and obtaining a range of the descendable node types for the node in response to the structure rules defining the node. The node represents a first element in the network. A child node, defined by a first node type within the range of node types is created. The child node represents a second element in the network, the second element being descendent from the first element. The child node is presented in association with the node in a network graph to document the network.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a schematic layout diagram of a telecommunications network;

FIG. 2 shows a block diagram of layers of the telecommunications network;

FIG. 3 shows a block diagram of a computing system for executing a computer program, in the form of a network documentation system, for documenting the telecommunications network;

FIG. 4 shows a table of an exemplary data structures database of the network documentation system of FIG. 3;

FIG. 5 shows a diagram of exemplary notation for a node type template of the network documentation system;

FIG. 6 shows a diagram of exemplary notation for a structure list template of the network documentation process;

FIG. 7 shows a diagram of exemplary notation for a link type template of the network documentation system;

FIGS. 8a-c show various illustrations of an exemplary network graph;

FIG. 9 shows a flowchart of an network documentation process;

FIG. 10 shows a flowchart of a node identification subprocess of the network documentation process;

FIG. 11 shows a flowchart of a link identification subprocess of the network documentation process;

FIG. 12 shows a flowchart of a circuit identification subprocess of the network documentation process;

FIGS. 13a-b show a data model and the network graph representing the telecommunications network at a network level created through the execution of the network documentation process;

FIGS. 14a-b show a data model and the network graph representing the telecommunications network at a site level created through the execution of the network documentation process;

FIGS. 15a-b show a data model and the network graph representing the telecommunications network at a Digital Access Cross-connect Switch (DACS) level created through the execution of the network documentation process;

FIGS. 16a-b show a data model and the network graph representing the telecommunications network at a DACS Unit level created through the execution of the network documentation process;

FIGS. 17a-b show a data model and the network graph representing the telecommunications network at a DACS logical elements layer created through the execution of the network documentation process; and

FIGS. 18a-b show a data model and the network graph representing the telecommunications network summarizing a Premisys hierarchy created through the execution of the network documentation process.

### DETAILED DESCRIPTION OF THE PREFERRED EMBODIMENTS

The present invention enables efficient modeling and documentation of elements and relationships in a network through the utilization of a common format. This common format allows for straightforward extension of a network model and network documentation.

The following is a glossary of terminology used herein:

Network: is any interconnected group or system. For example, a telecommunications network is a network of elements and connections arranged so that information may be passed from one part of the network to another.

Network Element: any physical or logical point of interest in a network.

Network Connection: a path between two directly connected network elements in a network.

Network Data Path: the route for information between two network elements in a network—particularly between two network elements that are not necessarily directly connected.

Site: is a geographic location in the network at which a collection of network elements is placed.

Data Model: a description of the structure and organization of the data in a database. Specifically, the data model makes explicit the tables' names, their contents, and how they are related to, and linked with, one another.

Network Graph: is the data model used herein to document the network. The constitution of the network graph is guided by node types, node structure lists, and link types. The network graph is a hierarchical graph, and the key elements of the network graph are also key components of graph theory, namely vertices (nodes), edges (parent edges and links), and paths (circuits). The elements of the network graph can be stored in a relational database since the vertices, edges, and paths share the same respective attributes.

Node: corresponds to a vertex in the network graph, and represents a point of interest, i.e., a network element, in the network. Every node is defined by exactly one node type. The node type governs all aspects of the node's structure and connectivity in the network graph.

Root Node: a node in the network graph at which all operations on the network graph begin. It is not a child node of any other node, and all other nodes can be reached from it by following parent edges.

Parent Node: a node in the network graph that links to one or more child nodes. Every parent node has the potential to have zero or more child nodes, where every child node references the present node as a parent.

Child Node (a.k.a. descendant node): a node in the network graph that is linked to by a parent node. Any child node may be subordinate to one parent node, but a parent node may have many subordinate child nodes.

Parent Edge: a unidirectional edge in the network graph between a parent node and a child node that indicates the child node is subordinate of the parent node pointed to by the parent edge. The parent edge establishes a “parent-child” relationship between two nodes.

Link (a.k.a. non-parent edge): a bidirectional edge in the network graph that defines a direct connection between two nodes in the network graph. A link represents a network connection in the network, and is dictated by the connectivity rules of the node type of a node.

Circuit: a continuous path in the network graph formed by links (non-parent edges) sequentially connecting nodes, that represents a network data path, i.e., a continuous data flow, through the network.

Node Type: is a modeling data structure of the present invention that contains structure rules for its immediate child (a.k.a. descendent) nodes and connectivity rules. Structure rules are based on node structure lists. Connectivity rules are based on link types.

Descendable Node Type: defines a node type that is allowable for a child node subordinate to a parent node and is dictated by the structure rules of the node type of the parent node. A total number of child nodes, up to a unit limit for every allowable descendable node type, need not necessarily be instantiated for every parent node.

Node Structure List: is a modeling data structure of the present invention that contains an ordered list of references to node types. The node structure list provides a finite range of node types to choose from when defining capacity for nodes of a particular node type. Node structure lists are referenced by node types via a list entry (reference to a node structure list) in the structure rules associated with a node type. Any given node structure list may be used in more than one node type.

Node Type Reference Attribute: uniquely identifies each entry in a node structure list. Each entry may optionally contain more attributes depending on the nature of the node type reference.

Link Type: is a modeling data structure of the present invention that defines the link that connects two nodes together. A link type limits the range of linkable nodes to those of a common link type. Link type is referenced by node type via connectivity rules. Any given link type may be referenced by a multiplicity of links, and every link is defined by exactly one link type.

Structure Rules: in a node type are an unordered list of rules, where each rule provides capacity for one or more child nodes. Structure rules possess at least two attributes of 1) a reference to a node structure list which defines a range of node types, and 2) a unit limit.

Range of Node Types: defines the particular node types that any child node must be defined by in order to descend from a parentnode.

Unit Limit: defines the upper limit on the child nodes of a particular node type from the range of node types that may be created for a particular parent node.

Connectivity Rules: in a node type are an ordered list of rules, where each rule provides a single point of connectivity. Connectivity rules possess at least the attribute of a reference to a link type.

Reference to a Link Type: defines the link type for the point of connectivity. Two points of connectivity (i.e., two nodes) may only be connected by a link provided they share a common link type.

Connection Index: provides an order for the connectivity rules of a node type. This allows for the layering of connectivity rules to infer the hierarchy of links.

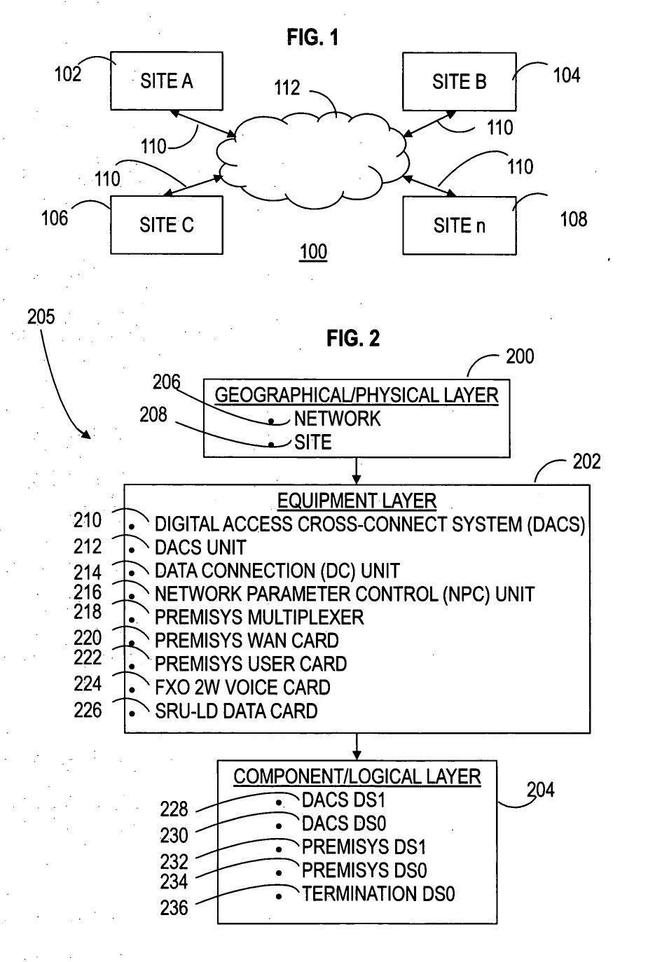

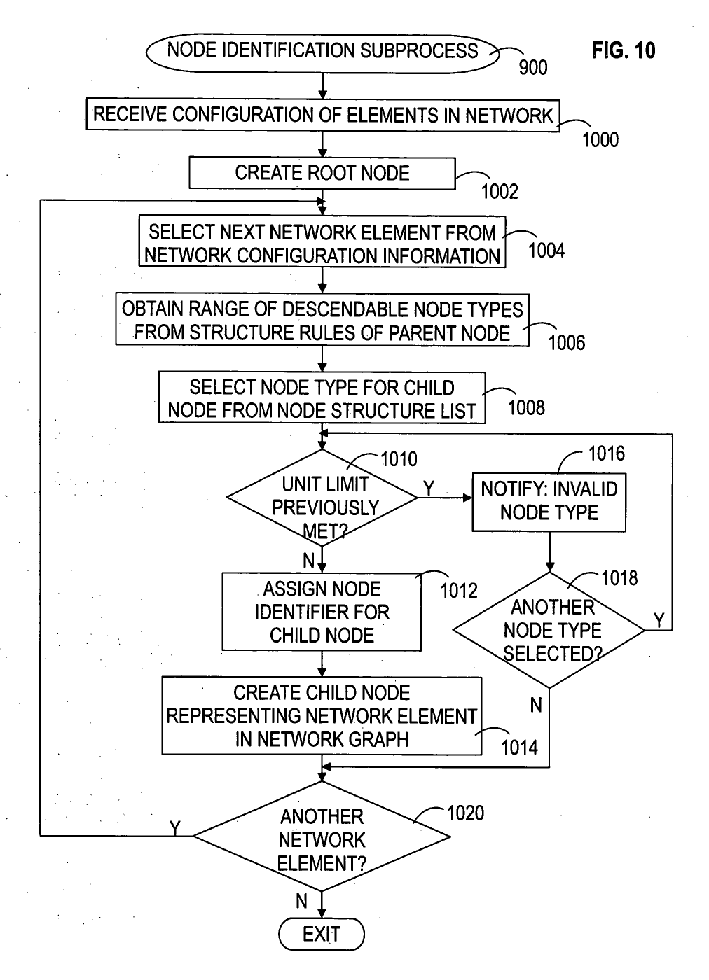

Throughout this discussion, items are assigned three- or four-digit reference numbers whose first digit or first two digits reflects the Figure in which the item first appears. That is, items first appearing in FIG. 1 are assigned reference numbers between 100 and 199, items first appearing in FIG. 2 are assigned reference numbers between 200 and 299, items first appearing in FIG. 10 are assigned reference numbers between 1000 and 1099, etc. Once assigned, a given reference number is used in all Figures in which that item appears.

### FIG. 1

FIG. 1 shows a schematic layout diagram of a telecommunications network 100. Network 100 includes a first site 102 labeled “SITE A”, a second site 104 labeled “SITE B”, a third site 106 labeled “SITE C”, and a multiplicity of additional sites 108 as represented by “SITE n”. Network connections, represented by bidirectional arrows 110 interconnect each of first, second, third, and multiplicity of sites 102, 104, 106, and 108 to a cloud element 112 representing network data paths, i.e., the interconnectivity of sites 102, 104, 106, and 108.

For purposes of the present discussion, bidirectional arrows 110 in network 100 represent physical paths between two directly connected network elements in network 100. Thus, the reference numeral “110” is used hereinafter to refer to network connections 110, representing any point of connectivity between two network elements at any level within network 100. Cloud element 112 shown in telecommunications network 100 represents the physical route for information between two network elements in telecommunications network, particularly between two network elements that are not necessarily directly connected. Thus, the reference numeral “112” is used hereinafter to refer to network data paths 112.

In an exemplary embodiment, network 100 is a telecommunications network. A telecommunications network includes the combination of numerous network elements that are required to support voice, data, or video services in local or long-distance applications. A telecommunications network can connect the end user to virtually anywhere in an enterprise or in the world through the use of copper cable, coaxial cable, and fiber cable—or through wireless technology such as microwave or satellite.

The present invention entails a computer-based method and computer program for modeling and documenting the network elements, i.e., physical and logical components, of telecommunications network 100. As will be discussed herein, the present invention utilizes a relational database with a fixed schema. Regardless of the size and variety of network 100, the database schema does not change. Instead, the diversity of network 100 is captured using three primary data structures, node type, node structure list, and link type, to create a network graph that reflects telecommunications network 100.

The present invention is described in connection with modeling and documenting telecommunications network 100. However, it should be understood that the present invention may be readily adapted to model and document a variety of complex networks. Other such complex networks entail, for example, an enterprise network. An enterprise network is the network (or interconnected networks) of computer systems owned by a large enterprise such as a corporation, which fills the enterprise's various computing needs. Such a network can span diverse geographical locations and usually encompasses a range of platforms, operating systems, protocols, and network architectures.

### FIG. 2

FIG. 2 shows a schematic diagram of layers of telecommunications network 100. In general, the natural hierarchy of a network, such as telecommunications network 100, may be summed up as three layers, a geographical/physical layer. 200, an equipment layer 202, and a component/logical layer 204. The elements within each of geographical/physical layer 200, equipment layer 202, and component/logical layer 204 are collectively referred to herein as network elements 205, or any physical or logical points of interest in network 100.

Geographical/physical layer 200 describes network elements 205 such as clusters of locations (NETWORK), generally referred to as network 206, and distinct locations 208 (SITE), collectively referred to as sites 208, where telecommunications equipment can be found. Geographical/physical layer 200 also encompasses physical devices that contain and organize equipment as well as provide pathways to other geographical locations in network 100.

Equipment layer 202 represents those network elements 205 that include the various telecommunications equipment used in network 100 to establish data flows through network 100. Connectivity at equipment layer 202 implies that the function of the equipment is relatively straightforward to describe. For purposes of illustration, network elements 205 of equipment layer 202 for telecommunications network 100 can include a digital access cross-connect system (DACS) 210, a DACS unit 212, a data connection (DC) unit 214, a network parameter control (NPC) unit 216, a Premisys multiplexer 218, a Premisys WAN card 220, a Premisys user card 222, an FXO 2W voice card 224, and an SRU-LD (subrate) data card 226. The term “Premisys” utilized herein, refers to a brand name for a family of network elements that have been defined, manufactured, and distributed by a particular organization, namely Premisys Communications. The Premisys line of network elements may be included in equipment layer 202 of a real-world telecommunications network. However, the Premisys brand of network elements is not a limitation of the present invention. Rather, it should be understood that equipment layer 202 can include many additional or alternative network elements 205.

Component/logical layer 204 encompasses all other network elements 205 in telecommunications network 100 that are within the equipment of equipment layer 202. These network elements 205 correspond to removable and interchangeable components of equipment, and connection points for bandwidth to other equipment or components. Component/logical layer 204 also captures the digital/logical network elements 205 like standard multiplexing hierarchies, such as, the Digital Signal (DS) multiplexing hierarchy. For purposes of illustration, network elements 205 of component/logical layer 204 for telecommunications network 100 can include a DACS DS1 (Digital Signal 1) 228, a DACS DS0 (Digital Signal 0) 230, a Premisys DS1 232, Premisys DSO 234, and a termination DSO 236. However, it should be understood that component/logical layer 204 can include various additional or alternative network elements 205.

Although the hierarchy of telecommunications network 100 is summarized herein as being three layers, it should be understood that this is not a limitation of the present invention. Rather, the hierarchy of a network under consideration may alternatively be summed up as having more or less than three layers.

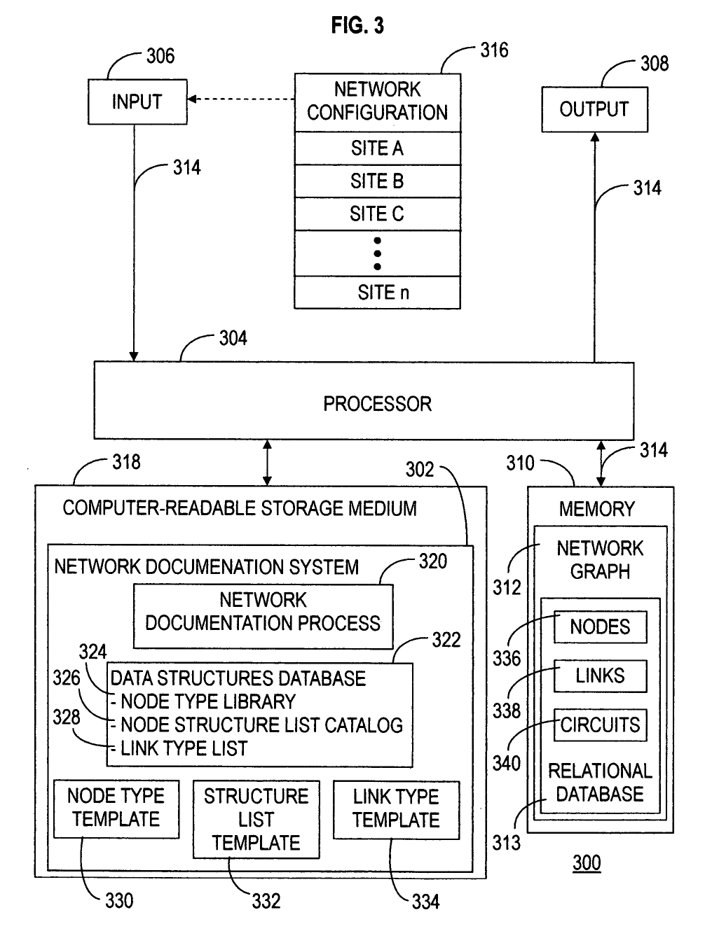

### FIG. 3

FIG. 3 shows a block diagram of a computing system 300 for executing a computer program, in the form of a network documentation system 302, for documenting telecommunications network 100. Computing system 300 includes a processor 304 on which the methods according to the invention can be practiced. Processor 304 is in communication with an input device 306, an output device 308, and a memory system 310 for storing a network graph 312 and an associated relational database 313 generated in response to the execution of network documentation system 302. These elements are interconnected by a bus structure 314.

Input device 306 can encompass a keyboard, mouse, pointing device, audio device (e.g., a microphone), and/or any other device providing input to processor 304. Of particular interest for input into computing system 300, is network configuration information 316 of network elements 205 within telecommunications network 100. Network configuration information 316, may be details of telecommunication network 100 retained in human memory, hand-written notes, a spreadsheet, a computer-aided design (CAD) drawing, or any other layout of network elements 205 and connectivity that describe all or a portion of telecommunications network 100 for which the designer wishes to document via network documentation system 302.

Output device 308 can encompass a display, a printer, an audio device (e.g., a speaker), and/or other devices providing output from processor 304. Input and output devices 306 and 308 can also include network connections, modems, or other devices used for communications with other computer systems or devices.

Computing system 304 also includes a computer-readable storage medium 318. Computer-readable storage medium 318 may be a magnetic disk, compact disk, or any other volatile or non-volatile mass storage system readable by processor 304. Computer-readable storage medium 318 may also include cooperating or interconnected computer readable media, which exist exclusively on computing system 300 or are distributed among multiple interconnected computer systems (not shown) that may be local or remote.

Network documentation system 302 is recorded on computer-readable storage medium 318 for instructing processor 304 to create hierarchical network graph 312, the elements of which can be stored in relational database 313, that models and documents network elements 205 of telecommunications network 100. Network documentation system 302 is executed by processor 304 in response to the receipt of network configuration information 316.

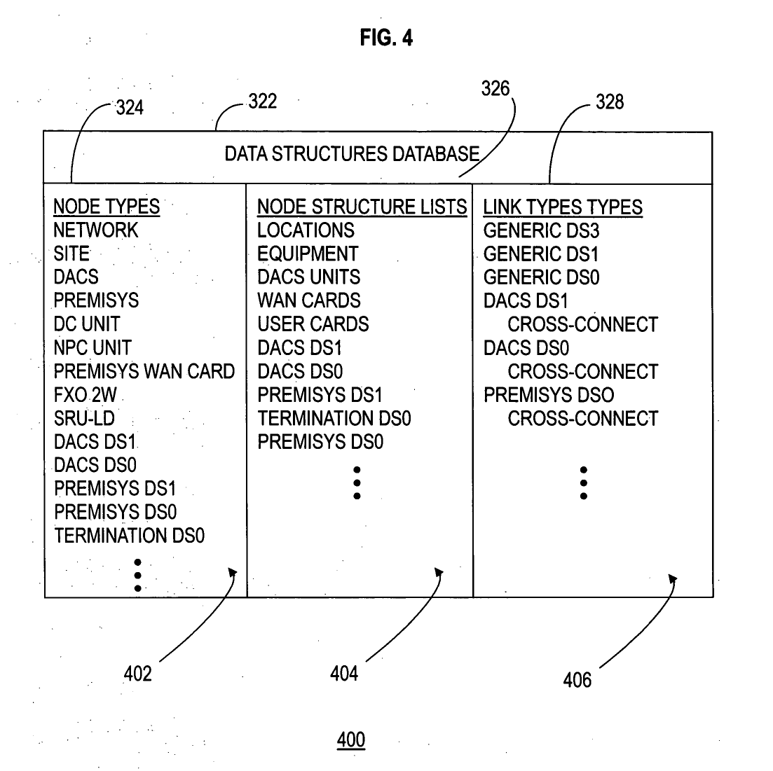

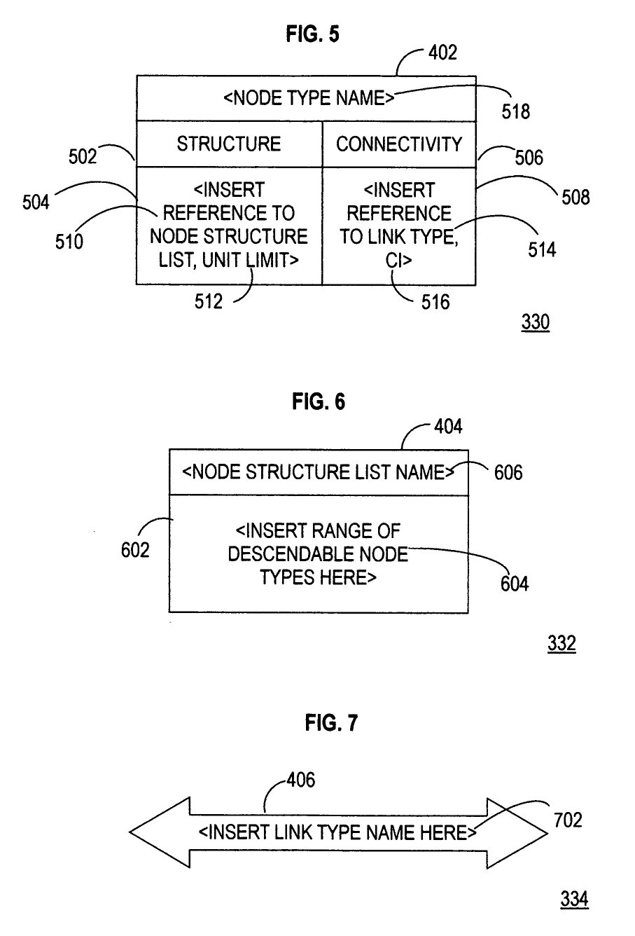

Network documentation system 302 includes executable code in the form of a network documentation process 320 for instructing processor 304 to create network graph 312 with relational database 313. Network documentation system 302 further includes a data structures database 322 that includes a node type library 324, a node structure list catalog 326, and a link type list 328. Data structures database 322 will be discussed in greater detail in connection with FIG. 4. Network documentation system 302 may also include program code represented herein by a node type template 330 (discussed in connection with FIG. 5), a structure list template 332 (discussed in connection with FIG. 6), and a link type template 334 (discussed in connection with FIG. 7).

In general, node type template 330, structure list template 332, and link type template 334 provide data abstraction, which hides the physical representation of data within “object” data structures, and thus lessens the impact of changes when modifications are made to the software. Data structures, also referred to as records or formats, are organizational schema applied to data so that it can be interpreted, and so that specific operations can be performed on that data. Such data structures are employed to impose a physical organization on network graph 312.

Modeling and documenting real-world telecommunications networks involves observing the natural hierarchy of the network, and then observing the connectivity that happens at each layer of that hierarchy. Given observed patterns of structure and connectivity, the challenge is to derive a model given any telecommunications network. Once the model has been derived, network elements 205 in the telecommunications network can be correlated to elements of the model to create network graph 312.

The modeling system of network documentation system 302 includes three main data structures that include node types, node structure lists, and link types which are defined and stored in data structures database 322. As existing and new technologies are introduced into the model, network documentation system 302 allows for these new technologies to be modeled by these three main data structures, utilizing node type template 330 for the node type, structure list template 332 for the node structure list, and link type template 334 for the link type. As these new technologies are modeled, the related node types, node structure lists, and link type lists can be saved in data structures database 322.

The documenting system of network documentation system 302 includes three main data structures that form network graph 312. These three main data structures include nodes 336 representing network elements 205, links 338 representing network connections 110, and circuits 340 representing network data paths 112. The information stored in data structures database 322 can be utilized when executing network documentation process 320 to create nodes 336, links 338, and circuits 340 in network graph 312.

### FIG. 4

FIG. 4 shows a table 400 of an exemplary data structures database 322 of network documentation system 302. As briefly mentioned above, data structures database 322 includes node type library 324, node structure list catalog 326, and link type list 328. Node type library 324 includes a plurality of data structures in the form of node types 402 constructed in accordance with node type template 330. Similarly, node structure list catalog 326 includes a plurality of data structures in the form of node structure lists 404 constructed in accordance with structure list template 332, and link type list 328 includes a plurality of data structures in the form of link types 406 constructed in accordance with link type template 334. The pre-existing node types 402, node structure lists 404, and link types 406 within data structures database 322 are advantageously utilized to create network graph 312 that reflects telecommunications network 100.

Data structures database 322 is illustrated in a highly simplified format for simplicity of description. Those skilled in the art of database configuration will recognize that database 322 can take on a great variety of forms.

### FIG. 5

FIG. 5 shows a diagram of exemplary notation for node type template 330 of network documentation system 302. Node type template 330 is notation utilized herein that represents the program code for generating each of node types 402. Node type 402 is a modeling data structure that contains rules for structure and connectivity of a class of nodes 336 in network graph 312. Node type template 330 for node type 402 includes a structure rule field 502 for entry of structure rules 504. In addition, node type template 330 for node type 402 includes a connectivity rule field 506 for entry of connectivity rules 508. Structure rules 504 are based on node structure lists 404, and connectivity rules 508 are based on link types 406.

Structure rules 504 can include a reference 510 to one of node structure lists 404 of allowable node types 402 for any child (i.e., descendent) nodes 336, and a unit limit 512 which defines the upper limit for child nodes 336 of the node types 402 drawn from the referenced node structure list 404. Connectivity rules 508 are an ordered list of rules, where each rule provides a single point of connectivity. Connectivity rules can include a reference 514 to one of link types 406, which defines the link type 406 for the point of connectivity for one of links 338, and a connection index (CI) attribute 516 which uniquely identifies each rule.

Node types 402 are uniquely identified by a name attribute 518. In addition, each of node types 402 may contain other attributes to further describe the nature of the particular one of node types 402.

Node types 402 correspond to the abstract vertex elements of telecommunications network 100. A container type, such as a class of geographic location or a specific type of equipment is represented by one of node types 402, with emphasis on structure rules 504 relating to the containable network elements 205. Connection points, such as equipment components, are also represented with node types 402, with emphasis on connectivity rules 508 to ensure that all possible connections can be modeled.

### FIG. 6

FIG. 6 shows a diagram of exemplary notation for structure list template 332 of the network documentation system 302. Structure list template 332 is notation utilized herein that represents the program code for generating each of node structure lists 404. Node structure list 404 is a modeling data structure that includes a structure list field 602 containing a finite range of node types 604 to choose from when defining capacity, i.e., any allowable type (descendable) child nodes 336, for a parent node 336. Range of node types 604 can include zero or more references (a node type reference attribute) to allowable (descendable) node types 402 for child nodes 336.

When one of nodes types 402 references one of node structure lists 404 via its corresponding structure rules 504, that one of node types. 402 is adding child node capacity equal to unit limit 512 delineated in structure rules 504 of the parent node 336. Node types 402 of any child nodes 336 are constrained by range of node types 604 provided in node structure list 404. Therefore, node structure list 404 pertains to node types 402 that could logically be contained by the referencing one of node types 402. For example, a piece of equipment would only reference node structure lists that contain node type references of equipment components that belong in that equipment. Any given one of node structure lists 404 may be used in more than one of node types 402. Each of node structure lists 404 are uniquely identified by a name attribute 606. In addition, node structure lists 404 may possess more attributes to further describe the nature of those lists 404.

### FIG. 7

FIG. 7 shows a diagram of exemplary notation for link type template 334 of network documentation system 302. Link type template 332 is notation utilized herein that represents the program code for generating each of link types 406. Link type 406 is a modeling data structure that defines a class of links 338 in network graph 312. One of link types 406 limits the range of linkable nodes to those that share the same one of link types 406. For this reason, link types 406 are referenced by node types 402 via connectivity rules 508. A data structure for link types 406 is a very simple structure used to define relationships between various classes of nodes 336. Link types 406 are uniquely identified by a name attribute 702, although each of link types 406 may possess more attributes to further describe the nature of those link types 406. Any given one of link types 406 may be referenced by a multiplicity of link types 406.

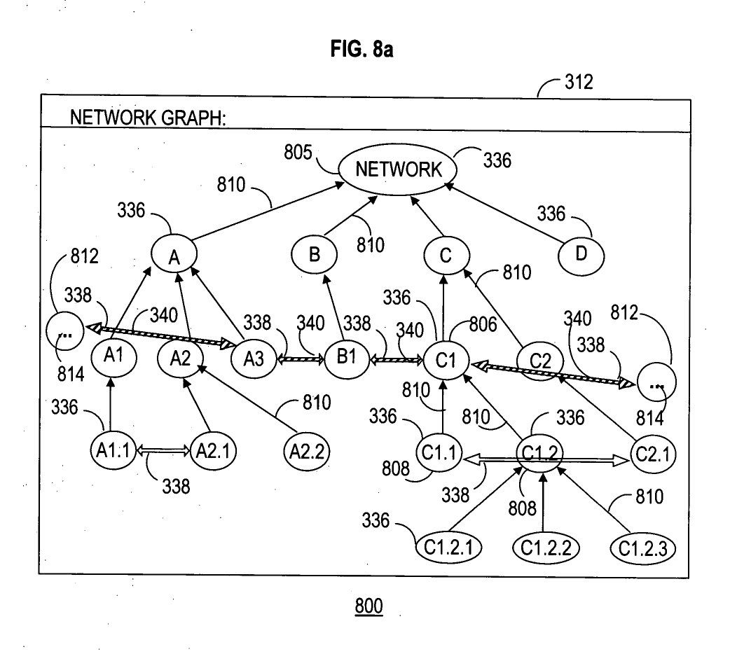

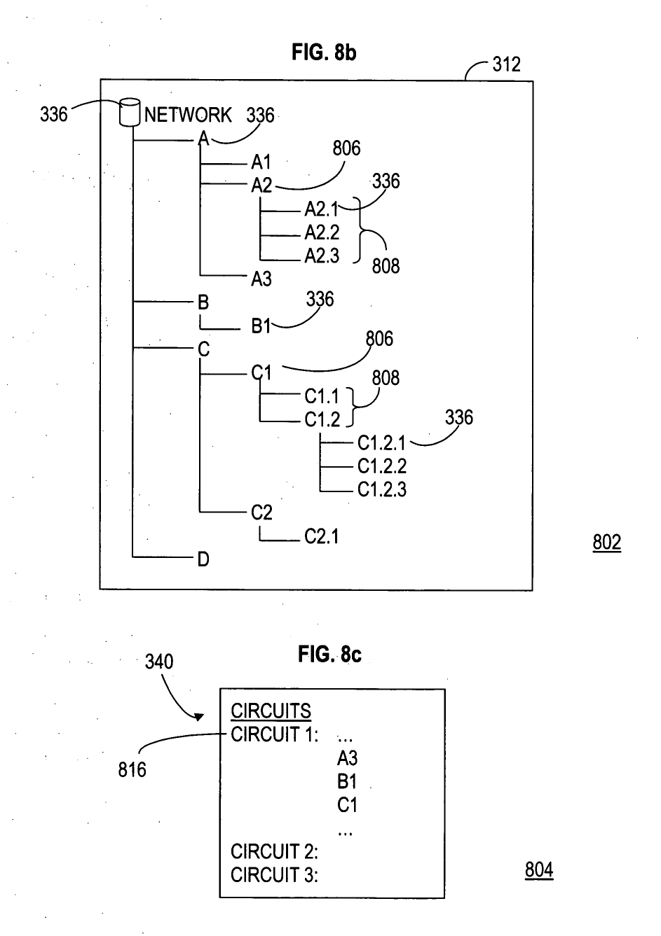

### FIGS. 8a-c

FIGS. 8a-c show various illustrations of an exemplary network graph 312 to demonstrate the various terms utilized herein. FIG. 8a shows an illustration of an exemplary network graph 312 arranged in a hierarchical tree structure 800. FIG. 8b shows an illustration of network graph 312 arranged in a nested hierarchical layout 802 as it may be presented to a user at output 308 of computing system 300. FIG. 8c shows a table 804 of circuits 340 within network graph 312 that may also be presented to a user at output 308 of computing system 300.

Through the execution of network documentation process 320 of network documentation system 302, discussed in detail in connection with subsequent figures, network graph 312 is produced. In hierarchical tree structure 800, network graph 312 includes a plurality of oval symbols representing nodes 336. Nodes 336 correspond to the various network elements 205 of telecommunications network 100.

For purposes of explanation, all oval symbols are nodes 336. Nodes can be further distinguished as a root node 805, parent nodes 806, and child nodes 808. For example, a node 336, labeled “C1” is one of parent nodes 806. Related nodes 336, labeled “C1.1” and “C1.2” are child nodes 808. The relationships between child nodes 808 and parent nodes 806 are represented by parent edges 810, i.e., unidirectional arrows, pointing from child nodes 808 to parent nodes 806.

Links 338 are illustrated in hierarchical tree structure 800 by bi-directional arrows connecting pairs of nodes 336. Each of circuits 340, is a continuous path in network graph 312 formed by links 338 sequentially connecting nodes 336. One of circuits 340 is illustrated in hierarchical tree structure 800 by links 338 sequentially connecting nodes 336, labeled A3, B1, and C1 and nodes 812 containing ellipses 814. Ellipses 814 indicate that circuit 340 extends beyond the nodes 336 and links 338 shown herein. Links 338 that make up the one of circuits 340 are cross-hatched for clarity of illustration.

Nested hierarchical layout 802 (FIG. 8b) also shows nodes 336, parent nodes 806, and child nodes 808. Nested hierarchical layout 802, as is commonly utilized in computing, is a nested organization of data, in this case nodes 336, that are separately identifiable but also part of a larger data organization. For example, child nodes 808, labeled “C1.1” and “C1.2”, and their ancestor nodes 336 are “contained” within parent node 806, labeled “C1”.

Table 804 (FIG. 8c) includes those circuits 340 that are identified within network graph 312. For example, a first one of circuits 340, is assigned a circuit identifier 816, that distinguishes it from all other circuits in table 804. This circuit 340 assigned with circuit identifier 816 corresponds to the one of circuits 340 illustrated in hierarchical tree structure 800.

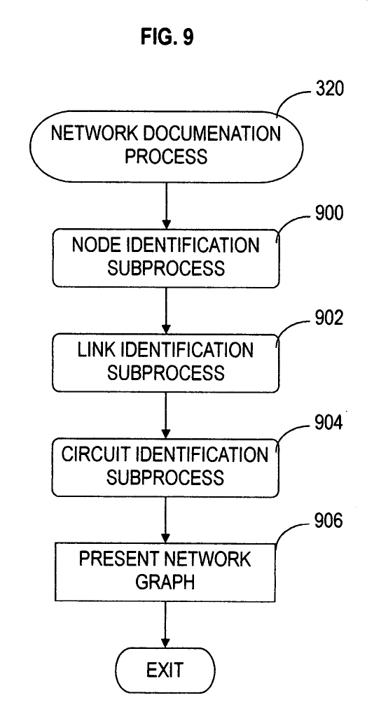

### FIG. 9

FIG. 9 shows a flowchart of network documentation process 320. Network documentation process 320 is executed by processor 304 of computing system 300 to document network elements 205 and the connectivity of existing network elements 205 within all or a portion of telecommunications network 100. In addition, network documentation process 320 is executed to document new network elements 205, to document a reconfiguration of network elements, and so forth.

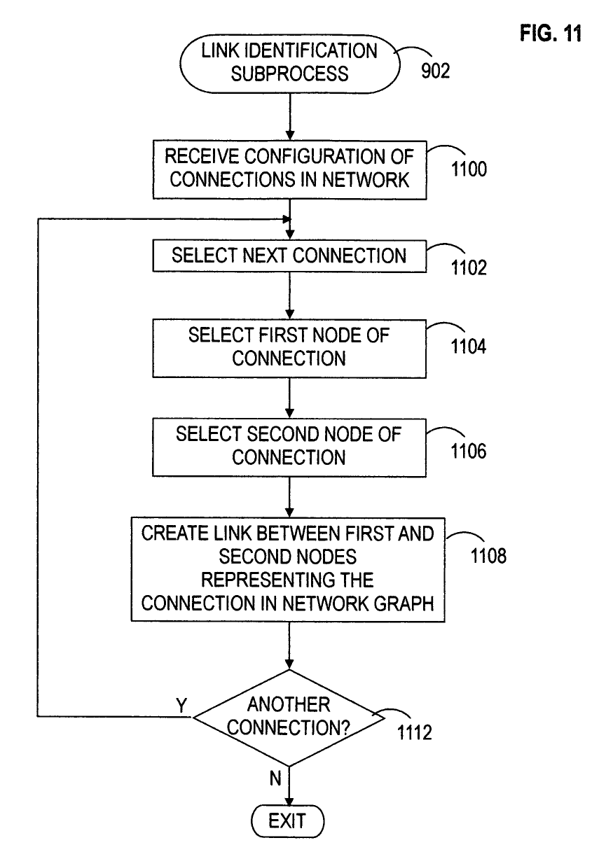

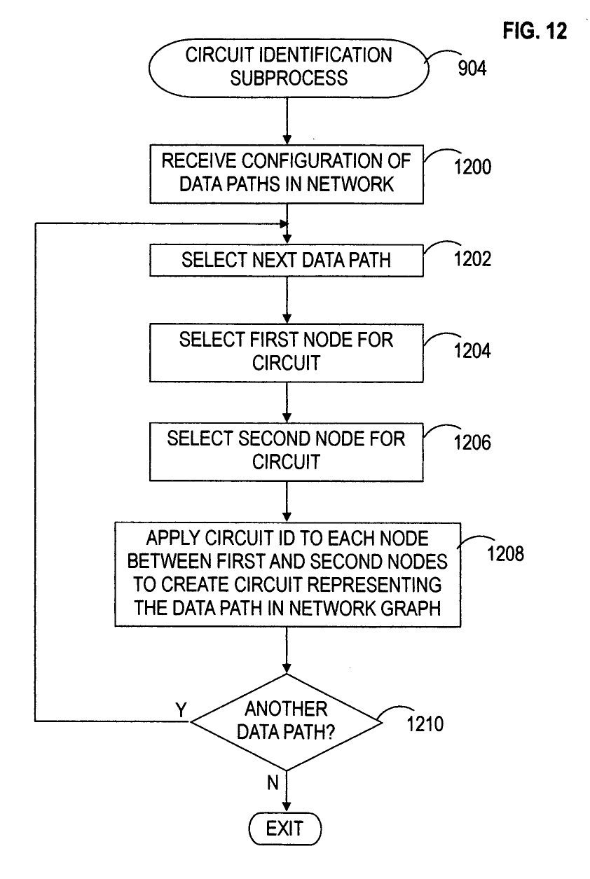

Network documentation process 320 involves the execution of a node identification subprocess 900. Node identification subprocess 900 is described in connection with FIG. 10. Following node identification subprocess 900, a link identification subprocess 902 is performed. Link identification subprocess 902 is described in connection with FIG. 11. Next, a circuit identification subprocess 904 is executed. Circuit identification subprocess 904 is described in connection with a FIG. 12.

Following the execution of subprocesses 900, 902, and 904, network documentation process 320 continues with a task 906. At task 906, network graph 312 is presented. Network graph 312 may be presented in numerous configurations, including, for example, hierarchical tree structure 800, nested hierarchical layout 802, table 804, and so forth. The specific configuration of network graph 312 is not critical to the present invention. Rather, it's the collection of data and relationships in relational database 313 (in the form of nodes 336, links 338, and circuits 340) that allows a user to efficiently document network elements 205 in a common format, and to view telecommunications network 100 at a high level down to very fine detail. Following presenting task 906, network documentation process 320 exits.

### FIG. 10

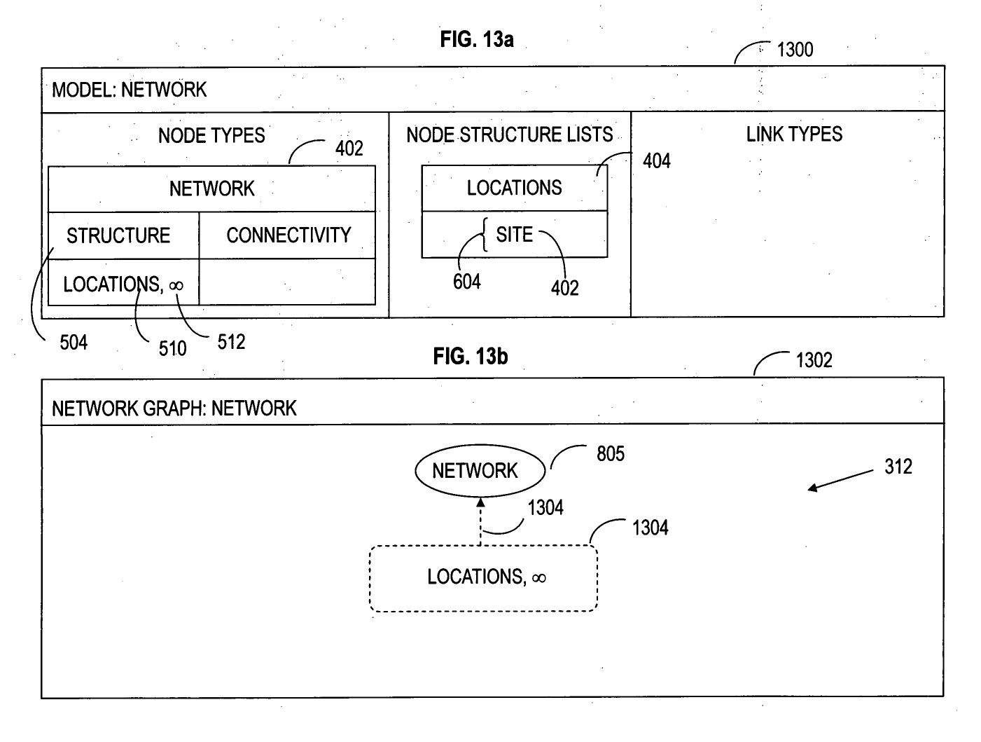

FIG. 10 shows a flowchart of node identification subprocess 900 of network documentation process 320. Node identification subprocess 900 is executed to instantiate nodes 336 in network graph 312 that represent existing network elements 205 within-telecommunications network 100. The tasks set forth in node identification subprocess 900 are presented in an exemplary sequence. This exemplary sequence assumes that the documentation of telecommunications network 100 begins at root node 805. However, the process steps discussed herein can take on great number of variations and can be performed in a differing order then that which was presented. Moreover, network graph 312 can be further compiled as additional information regarding telecommunications network 100 becomes available. Node identification subprocess 900 is described in general terms herein, and is described in connection with an example set forth beginning at FIG. 13.

Node identification subprocess 900 begins with a task 1000. At task 1000, network configuration information 316 is received. Network configuration information 316 can include a compilation of some or all of network elements 205 for telecommunications network 100. This compilation of information can be in the form of data retained in human memory, a spreadsheet, a CAD drawing, or any other layout of network elements 205 for which a user is seeking to document.

In response to task 1000, a task 1002 is performed. At task 1002, root node 805, referred to hereinafter as network node 805 is created. Network node 805 may be automatically generated from program code of node identification subprocess 900 upon execution of task 1002. Consequently, creation of network node 805 at task 1002 may merely entail the selection of a unique identifier for network node 805.

Following task 1002, a task 1004 is performed. At task 1004, the user selects a next one of network elements 205 to be documented from network configuration information 316. During a first iteration of node identification subprocess 900, selection of a “next” one of network elements 205 will entail selection of a first one of network elements 205.

At task 1004, any of network elements 205, such as those listed in the layered construct of FIG. 2, may be selected. Since telecommunications network 100 is hierarchical in nature, thus yielding a corresponding network graph 312 that is hierarchical in nature, it may be most practical to start at the highest level, for example, at geographical/physical layer 200, then document through equipment layer 202, followed by component/logical layer 204. However, the order of documentation of network elements 205 is not a limitation of the present invention. Rather, the documentation of network elements 205 and their instantiation into nodes 336 representing those network elements 205 can occur in an order deemed practical by the user. For purposes of discussion, it will be assumed that the next one of network elements 205 is descendent from a previously selected one of network elements 205 or from root node 805.

In response to task 1004, a task 1006 is performed. At task 1006, a range of descendable nodes types 604 is obtained via structure rules 504 of parent node 806. More specifically, range of descendable node types 604 are referred to through node structure lists 404 referenced in structure rules 504 of parent node 806.

Next, a task 1008 is performed. At task 1008, one of node types 402 from range of descendable node types 604 is selected for child node 808 from the one of node structure lists 404 referenced in structure rules 504 of parent node 806.

A task 1010 is performed in conjunction with task 1008. At task 1010, processor 304 determines whether unit limit 512 was previously met for the total number of allowable child nodes 808 of the node types 402 referred to in the received one of node structure lists 404. When unit limit 512 has not been met, program control proceeds to a task 1012.

At task 1012, a unique node identifier is assigned for child node 808, and node identification subprocess 900 proceeds to a task 1014.

At task 1014, processor 304 creates child node 808 representing the selected one of network elements 205 in network graph 312. That is, child node 808 and its relationship to parent node 806 are saved in network graph 312.

Referring back to task 1010, when unit limit 512 was previously met, subprocess 900 proceeds to a task 1016. At task 1016, processor 304 may produce a message at output 308 informing the user that the selected one of node types 402 for child node 808 is invalid. That is, child node 808 cannot be defined by range of descendable node types 604 referred to in the received one of node structure lists 404.

Following task 1016, program control proceeds to a query task 1018. Structure rules 504 of parent node 806 may refer to more than one of node structure lists 404. Consequently, at query task 1018, a determination is made as to whether one of node types 402 from another node structure list 404 referenced in structure rules 504 of parent node 806 has been selected. When another one of node types 402 has been selected, program control loops back to query task 1010 to repeat the process of checking unit limit 512 and to attempt creation of one of child nodes 808 of one of the node types 402 referred to in the next selected one of node structure lists 404.

However, when query task 1018 determines that another node structure list 404 is not selected, node identification subprocess 900 proceeds to a query task 1020. Similarly, following the previously discussed task 1014 at which one of child nodes 808 was created, node identification subprocess 900 proceeds to query task 1020. At query task 1020, a determination is made as to whether there is another one of network elements 205 in network configuration information 316 to document. When there is another one of network elements 205 to be documented, node identification subprocess 900 loops back to task 1004 to repeat node identification subprocess 900 for the next one of network elements 205 from network configuration information 316. However, when there are no further network elements 205 to be documented, node identification subprocess 900 exits. Thus, node identification subprocess 900 specifies nodes 336 and establishes node lineage to a granularity, i.e., a level of detail, desired by the user from geographical/physical layer 200, through equipment layer 202, and through component/logical layer 204. Moreover, nodes 336 are specified in a common format, regardless of any specific network element, and/or hardware or logical component.

### FIG. 11

FIG. 11 shows a flowchart of link identification subprocess 902 of network documentation process 320. Link identification subprocess 902 is executed to instantiate links 338 in network graph 312 that represent existing network connections 110 within telecommunications network 100. The tasks set forth in link identification subprocess 902 are presented in an exemplary sequence. However, the process steps discussed herein can take on great number of variations and can be performed in a differing order then that which was presented. Moreover, network graph 312 can be further compiled as additional information regarding telecommunications network 100 becomes available. Link identification subprocess 902 is described in general terms herein, and is described in connection with an example set forth beginning at FIG. 13.

Link identification subprocess 902 begins with a task 1100. At task 1100, network configuration information 316 is received. Network configuration information 316 can include a compilation of some or all of network connections 110 for telecommunications network 100. This compilation of information can be in the form of data retained in human memory, a spreadsheet, a CAD drawing, or any other layout of network elements 205 for which a user is seeking to document.

In response to task 1100, a task 1102 is performed. At task 1102, the user selects a next one of network connections 110 to be documented from network configuration information 316. During a first iteration of link identification subprocess 902, selection of a “next” one of network connections 110 will entail selection of a first one of network connections 110. Since the present invention entails documentation of an existing telecommunications network, knowledge of a physical path between two directly connected network elements 205, i.e., one of network connections 110, also implies knowledge of the two network elements 205 that are directly connected via network connection 110.

Next, a task 1104 is performed. At task 1104, the user via computing system 300 selects a first one of nodes 402 representing in network graph 312 one of the two network elements 205 that are directly connected via the selected one of network connections 110.

Similarly, a task 1106 is performed. At task 1106, the user via computing system 300 selects a second one of nodes 402 representing in network graph 312 the other of the two network elements 205 that are directly connected via the selected one of network connections 110.

Following tasks 1104 and 1106, a task 1108 is performed. At task 1108, processor 304 creates in network graph 312 one of links 336 between first and second nodes 402 that represents the selected one of network connections 110. That is, one of links 336 and its relationship to first and second nodes 402 are saved in network graph 312.

Following task 1108, a query task 1110 is performed to determine whether there is another one of network connections 110 in network configuration information 316 to document. When there is another one of network connections 110 to be documented, link identification subprocess 902 loops back to task 1102 to repeat link identification subprocess 902 for the next one of network connections 110 from network configuration information 316. However, when there are no further network connections 110 to be documented, link identification subprocess 902 exits. Thus, link identification subprocess 902 specifies links 338 to a granularity, i.e., a level of detail, desired by the user from geographical/physical layer 200, through equipment layer 202, and through component/logical layer 204. Moreover, links 338 are specified in a common format, regardless of any specific network connection or type of connectivity.

### FIG. 12

FIG. 12 shows a flowchart of circuit identification subprocess 904 of network documentation process 320. Circuit identification subprocess 904 is executed to instantiate circuits 340 in network graph 312 that represent existing network data paths 112 within telecommunications network 100. The tasks set forth in circuit identification subprocess 904 are presented in an exemplary sequence. However, the process steps discussed herein can take on great number of variations and can be performed in a differing order then that which was presented. Moreover, network graph 312 can be further compiled as additional information regarding telecommunications network 100 becomes available.

Circuit identification subprocess 904 begins with a task 1200. At task 1200, network configuration information 316 is received. Network configuration information 316 can include a compilation of some or all of network data paths 112 for telecommunications network 100. This compilation of information can be in the form of data retained in human memory, a spreadsheet, a CAD drawing, or any other layout of network elements 205 for which a user is seeking to document.

In response to task 1200, a task 1202 is performed. At task 1202, the user selects a next one of network data paths 112 to be documented from network configuration information 316. During a first iteration of circuit identification subprocess 904, selection of a “next” one of network data paths 112 will entail selection of a first one of network data paths 112. Since the present invention entails documentation of an existing telecommunications network, knowledge of a physical route for information between two network elements in a network—particularly between two network elements that are not necessarily directly connected, i.e., one of network data paths 112, also implies knowledge of the multiple network elements 205 that are connected via network data paths 112.

Next, a task 1204 is performed. At task 1204, the user via computing system 300 selects a first one of nodes 402 representing in network graph 312 one of the multiple network elements 205 that are connected via the selected one of network data paths 112.

Similarly, a task 1206 is performed. At task 1206, the user via computing system 300 selects a second one of nodes 402 representing in network graph 312 another of the multiple network elements 205 that are connected via the selected one of network data paths 112.

Following tasks 1204 and 1206, a task 1208 is performed. At task 1208, processor 304 creates in network graph 312 one of circuits 340 between first and second nodes 402 that represents the selected one of network data paths 112. That is, a unique circuit identifier, exemplified by identifier 816, is applied to each one of nodes 336 between first and second nodes 402 selected in tasks 1204 and 1206 to create one of circuits 340 representing the selected one of network data paths 112. Information pertaining to the newly created one of circuits 340 is subsequently saved in network graph 312.

Following task 1208, a query task 1210 is performed to determine whether there is another one of network data paths 112 in network configuration information 316 to document. When there is another one of network data paths 112 to be documented, circuit identification subprocess 904 loops back to task 1202 to repeat circuit identification subprocess 904 for the next one of network data paths 112 from network configuration information 316. However, when there are no further network data paths 112 to be documented, circuit identification subprocess 904 exits. Thus, circuit identification subprocess 904 specifies circuits 340 in network graph 312 in a common format, regardless of any specific network connection or type of connectivity.

The following discussion illustrates an exemplary documentation scenario in which network documentation system 302 is employed to document telecommunications network 100.

### FIGS. 13a-b

FIGS. 13a-b show a data model 1300 and network graph 312 representing telecommunications network 100 at a network level 1302 created through the execution of network documentation process 320. The entire telecommunications network 100 may be thought of as one of network elements 205 of geographical/physical layer 200.

For the purposes of this example, an assumption is made that network 100 is composed of sites. Consequently, data model 1300 at network level 1302 need only serve as a “container” representing network elements 205, expressly, sites 208, such as sites 102, 104, 106, and 108, in telecommunications network 100. This can be accomplished with a single “Network” node type 402 and a single “Locations” node structure list 404.

Structure rules 504 of “Network” node type 402 includes reference 510 to only one of node structure lists 404, i.e. “Locations” node structure list 404, with unit limit 512 for descendable node types 402 provided in “Locations” node structure list 404 being infinite. “Locations” node structure list 404 contains range of descendable node types 604 that only includes a “Site” node type 402.

When relating data model 1300 to telecommunications network 100 in network graph 312, only one instance of “Network” root node 805 defined by “Network” node type 402 is needed at network level 1302 of network graph 312. This represents the root node for network graph 312. Dashed line items 1304 presented in network graph 312 herein and throughout the remaining figures represent capacity that has not yet been instantiated in network graph 312.

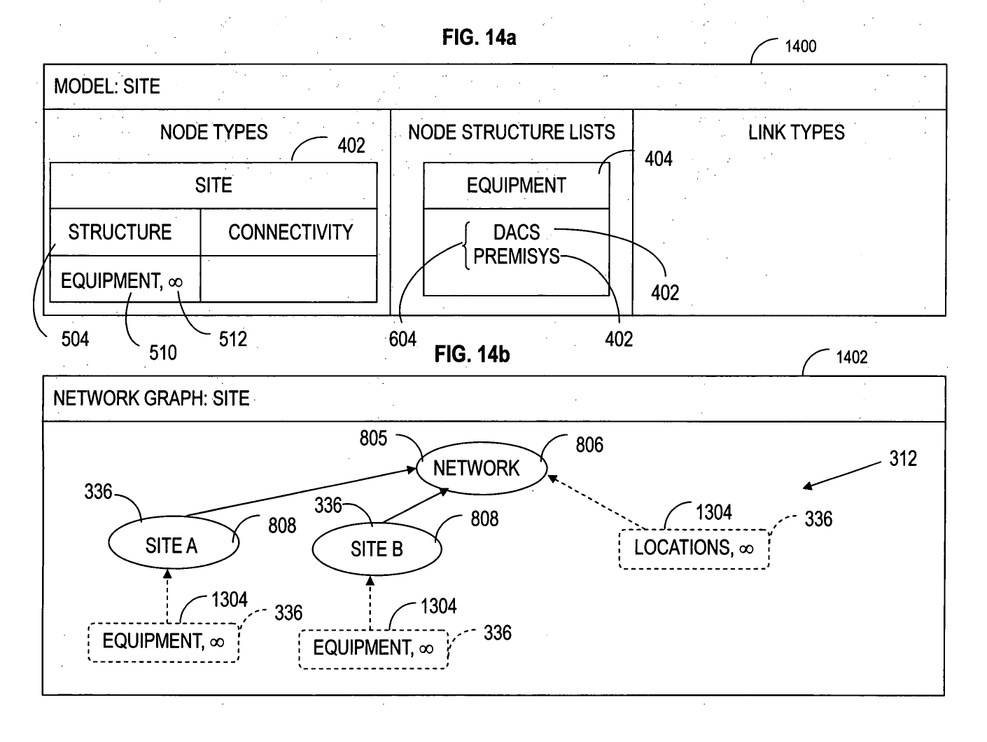

### FIGS. 14a-b

FIGS. 14a-b show a data model 1400 and network graph 312 representing telecommunications network 100 at a site level 1402 created through the execution of network documentation process 320. Sites 208, such as sites 102, 104, 106, and 108, are locations in geographical/physical layer 200, and compose the majority of telecommunications network 100. In this example, they can contain any number and type of equipment.

Data model 1400 at site level 1402 need only serve as a “container” for the defined equipment node types 402. This can be accomplished with a single “Site” node type 402 and a single “Equipment” node structure list 404. For purposes of this example, connectivity is not necessary directly to a site.

Structure rules 504 of “Site” node type 402 include reference 510 to only one of node structure lists 404, i.e. “Equipment” node structure list 404, with unit limit 512 for descendable node types 402 provided in “Equipment” node structure list 404 being infinite. “Equipment” node structure list 404 contains range of descendable node types 604 that includes a “DACS” node type 402 and a “Premisys” node type 402.

When relating data model 1400 to telecommunications network 100 at site level 1402 in network graph 312, “Network” root node 805, becomes parent node 806. “Network” root node 805 can contain multiple uniquely identified “Site” nodes 336, that are child nodes 808 to “Network” node 805. In this example, a first “Site” node 336, labeled “Site A” representing first site 102 within telecommunications network 100 has been instantiated. Likewise, a second “Site” node 336, labeled “Site B” representing second site 104 within network 100 has been instantiated. Ideally, for every site in telecommunications network 100, an instance of “Site” node 336 should be created in network graph 312.

Dashed line items 1304 encircling “Locations,∞” indicates that additional nodes 336 defined by node types 402 specified in “Locations” node structure list 404 have not yet been instantiated, and dashed line items 1304 encircling “Equipments,∞” indicates that additional nodes 336 defined by node types 402 specified in “Equipment” node structure list 404 have not yet been instantiated.

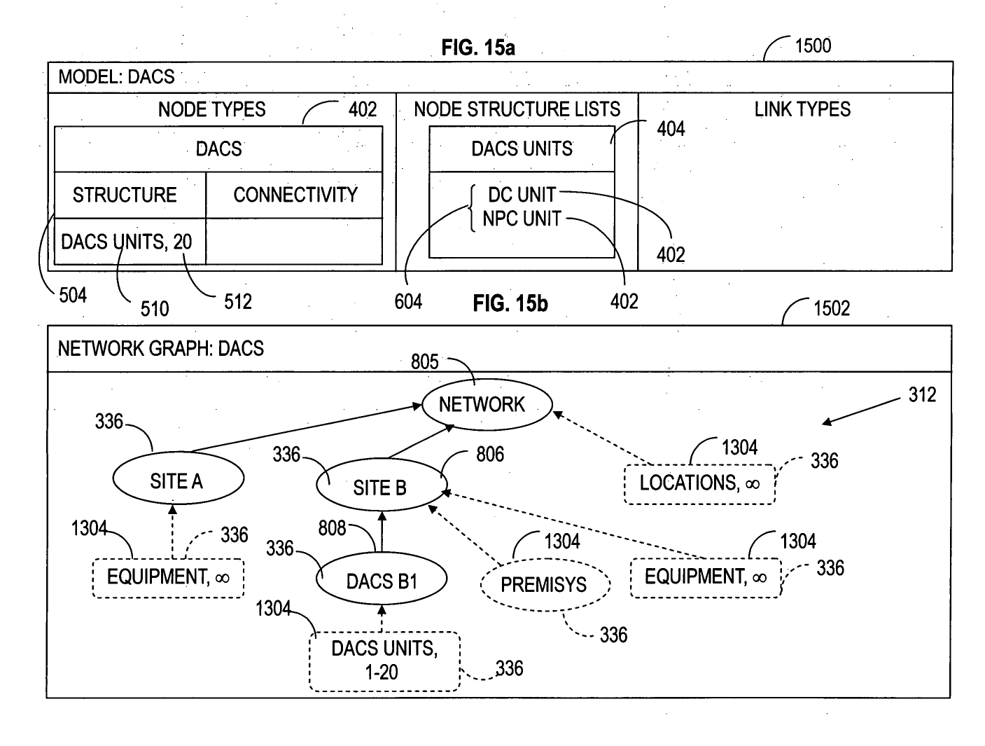

### FIGS. 15a-b

FIGS. 15a-b show a data model 1500 and network graph 312 representing telecommunications network 100 at a Digital Access Cross-connect System (DACS) level 1502 created through the execution of network documentation process. 320. An important type of equipment in telecommunications network 100 is DACS 210. DACS 210 allows for the grooming of high-bandwidth data lines (DS3's) at their most granular levels (DS0's). Network elements 205, in the form of DACS 210, are very expandable to accommodate a high volume of cross-connecting traffic.

For purposes of this example, connectivity is not needed at DACS level 1502, so data model 1500 can be accomplished with a single “DACS” node type 402 and a single “DACS Units” node structure list 404. Structure rules 504 of “DACS” node type 402 include reference 510 to only one of node structure lists 404, i.e. “DACS Units” node structure list 404. For the purpose of this example, unit limit 512 for descendable node types 402 provided in “DACS units” node structure list 404 is limited to twenty. “DACS units” node structure list 404 contains range of descendable node types 604 that includes a “DC Unit” node type 402 and a “NPC Unit” node type 402.

When relating data model 1500 to telecommunications network 100 at site level 1502 in network graph 312, “Site” nodes 336 representing sites 208, become parent nodes 806. Each of “Site” nodes 336 can contain multiple uniquely identified “DAC” nodes 336, that are child nodes 808 to their corresponding “Site” nodes 336. In this example, a “DACS” node 336, labeled “DACS B1”, represents one of DACS network elements 210 within second “Site” node 336, labeled “Site B” representing second site 104 within telecommunications network 100. Documentation entails for every “DACS” network element 210 in every site in telecommunications network 100, an instance of “DACS” node 336 defined by “DACS” node type 402 should be created.

Dashed line items 1304 encircling “Premisys” indicates that additional nodes 336 defined by “Premisys” node types 402 specified in “Equipment” node structure list 404 (see FIG. 14a) have not yet been instantiated, and dashed line items 1304 encircling “DACS Units, 1-20” indicates that additional nodes 336 defined by node types 402 specified in “DACS Units” node structure list 404 up to unit limit 512 of twenty have not yet been instantiated.

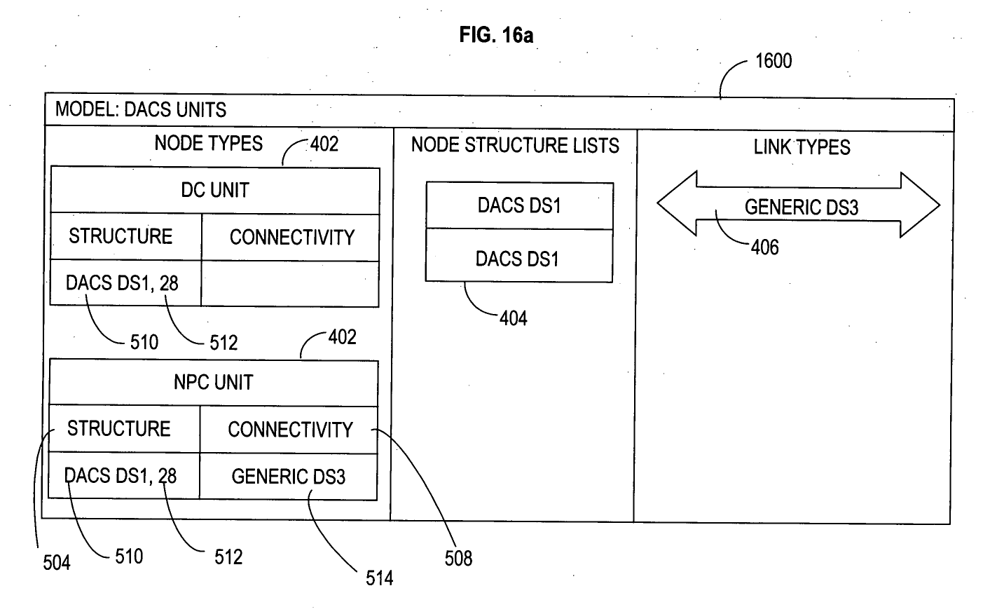

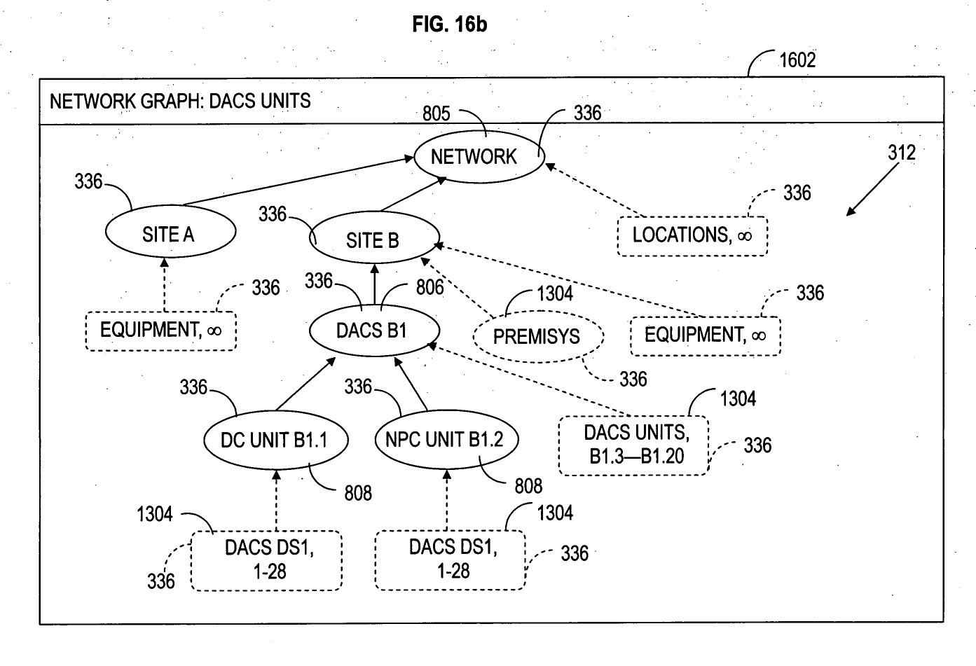

### FIGS. 16a-b

FIGS. 16a-b show a data model 1600 and network graph 312 representing telecommunications network 100 at a DACS Unit level 1602 created through the execution of network documentation process 320. DACS unit network elements 212 accept digital signal (DS3 and DS1) connections from other equipment sharing the same geographical location as DACS network elements 210, and then break those signals down into their constituent components.

Data model 1600 can be accomplished with two of node types 402, a “DC unit” node type 402 and an “NPC unit” node type 402. A DC unit network element 214 is composed of twenty-eight data connections (DCs), whereas an NPC unit network element 216 is composed of twenty-eight network parameter controls (NPCs). As known to those skilled in the art, each DC or NPC is effectively a DS1 and has the same functionality for grooming DS0 signals within DACS 210. Consequently, structure rules 504 of both “DC unit” and an “NPC unit” node types 402 include reference 510 to one of node structure lists 404, i.e. “DACS DS1” node structure list 404, limited by unit limit 512 to twenty-eight. NPC network element 216 accepts a DS3 connection from any other piece of equipment, which is then groomed into its constituent DS1s and DS0s. Consequently, “NPC Unit” node type. 402 includes connectivity rules 508 with reference 514 to “Generic DS3” link type 406.

When relating data model 1600 to telecommunications network 100 at DACS Unit level 1602 in network graph 312, “DACS” nodes 336, become parent nodes 806. Each of “DACS” nodes 336 can contain up to twenty uniquely identified “DACS Units” nodes 336 (which can be any combination of DC units and NPC units up to unit limit 512 of twenty), that are child nodes 808 to their corresponding parent “DACS” nodes 336.

In this example, a “DACS Units” node 336, labeled “DC Unit B1.1”, represents one of DACS unit network elements 212 within “DACS” node 336, labeled “DACS B1. In addition, a “DACS Units” node 336, labeled NPC Unit B1.2” represents another one of DACS unit network elements 212 within “DACS” node 336, labeled “DACS B1. Documentation entails for every “DACS unit” network element 212 in every site in telecommunications network 100, an instance of “DACS Units” node 336 defined by either “DC Units” node type 402 or “NPC Units” node type 402 should be created.

Dashed line item 1304 encircling “DACS Units, B1.3-B1.20” indicates that additional nodes 336 defined by “DACS Units” node types 402 specified in “DACS Units” node structure list 404 up to unit limit 512 of twenty have not yet been instantiated. Similarly, dashed line items 1304 encircling “DACS DS1, 1-28” indicates that additional nodes 336 defined by node types 402 specified in “DACS DS1” node structure list 404 up to unit limit 512 of twenty-eight have not yet been instantiated.

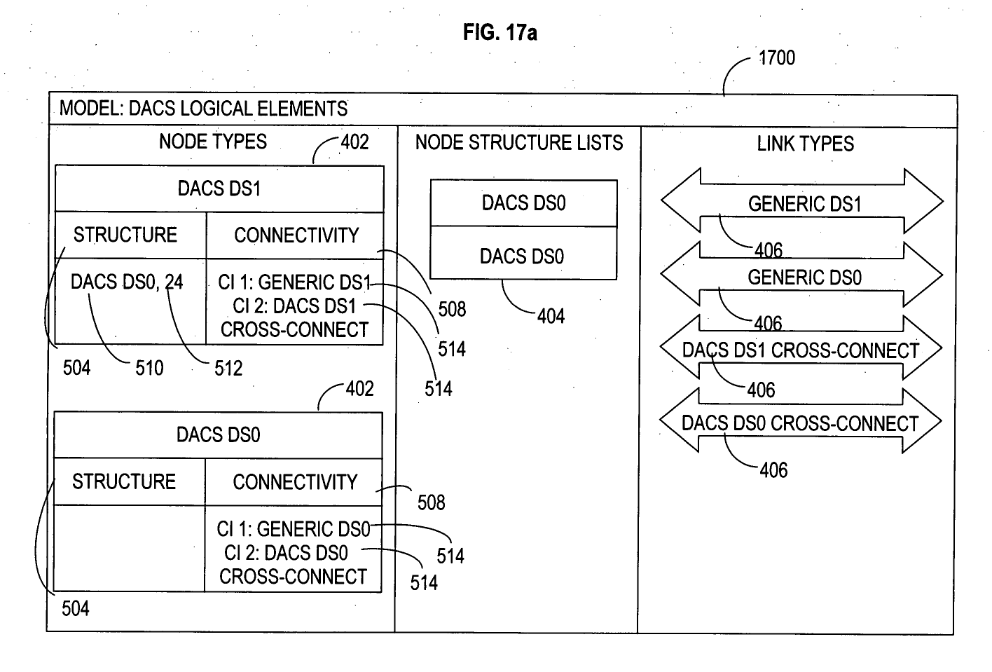

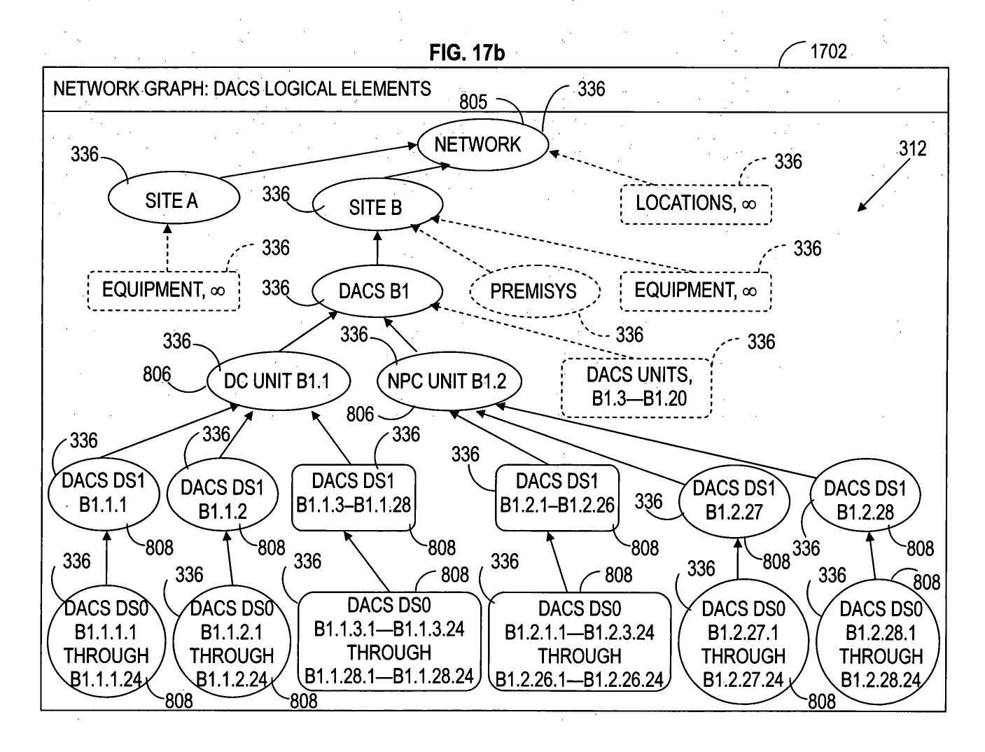

### FIGS. 17a-b

FIGS. 17a-b show a data model 1700 and network graph 312 representing telecommunications network 100 at a DACS logical elements level 1702 created through the execution of network documentation process 320. Within DC units network elements 214 and NPC units network elements 216, other logical structures exist to capture the digital signal multiplexing hierarchy supported by DACS network element 210.

The DACS DS1 228 in DC units 214 and NPC units 216 exist at component/logical layer 204. By definition, it is a hierarchy of twenty-four DS0s. Data model 1700 can be accomplished with two of node types 402, a “DACS DS1” node type 402 and a “DACS DS0” node type 402. Structure rules 504 of “DACS DS1” node type 402 includes reference 510 to one of node structure lists 404, i.e. “DACS DS0” node structure list 404, limited by unit limit 512 to twenty-four. As is known to those skilled in the art, a DACS DS1 network element 228 will accept a generic DS1 network connection 110 from network elements 205 (unless it is used in an NPC unit network element 205). DACS DS1 network element 228 may also accept a DS1 cross-connect network connection 110 from another DC unit network element 214 or NPC unit network element 216 in DACS network element 210. Consequently, “DACS DS1” node type 402 includes connectivity rules 508 with reference 514 to “Generic DS1” link type 406 and “DACS DS1 Cross-connect” link type 406.

The DACS DS0 network elements 230 also exist at component/logical layer 204. DACS DS0 is the base bandwidth in the digital hierarchy. Thus, structure rules 504 of “DACS DS0” node type 402 does not include reference 510 to one of node structure lists. As is known to those skilled in the art, a DACS DS0 network element 230 will accept a generic DS0 network connection 110 by definition since its DS1 parent will always accept a generic DS1 network connection 110. A DACS DS0 230 may also accept a DS0 cross-connect from another DS0 in DACS network element 205. Consequently, “DACS DS0” node type 402 includes connectivity rules 508 with reference 514 to “Generic DS0” link type 406 and “DACS DS0 Cross-connect” link type 406.

When relating data model 1700 to telecommunications network 100 at DACS logical elements level 1702 in network graph 312, “DACS Unit” nodes 336 (which can be any combination of DC units and NPC units), become parent nodes 806. Each of “DACS Units” nodes 336 can contain up to twenty-eight uniquely identified “DACS DS1” nodes 336, that are child nodes 808 to their corresponding “DACS Unit” nodes 336.

In this example, “DACS DS1” nodes 336, labeled with indices “B1.1.1”, “B1.1.2”, and “B1.1.3-B1.1.28” represent DACS DS1 network elements 228 within “DC Unit” node 336, labeled “DC Unit B1.1”. Similarly, “DACS DS1” nodes 336, labeled with indices “B1.2.1-B1.2.26”, “B1.2.27”, and “B1.2.28” represent DACS DS1 network elements 228 within “NPC Unit” node 336, labeled “NPC Unit B1.2”. Documentation entails for every “DACS unit” network element 214 in every site in telecommunications network 100, an instance of “DACS Units” node 336 defined by either “DC Units” node type 402 or “NPC Units” node type 402 should be created. Moreover, every “DACS DS1” node 336 must be created since they are not optional. In a preferred embodiment, the non-optional child nodes 808 may be automatically created through the execution of network documentation process 320. Dashed line items 1304 are not illustrated in at DACS logical elements level 1702 due to the forced creation of required child nodes 808.

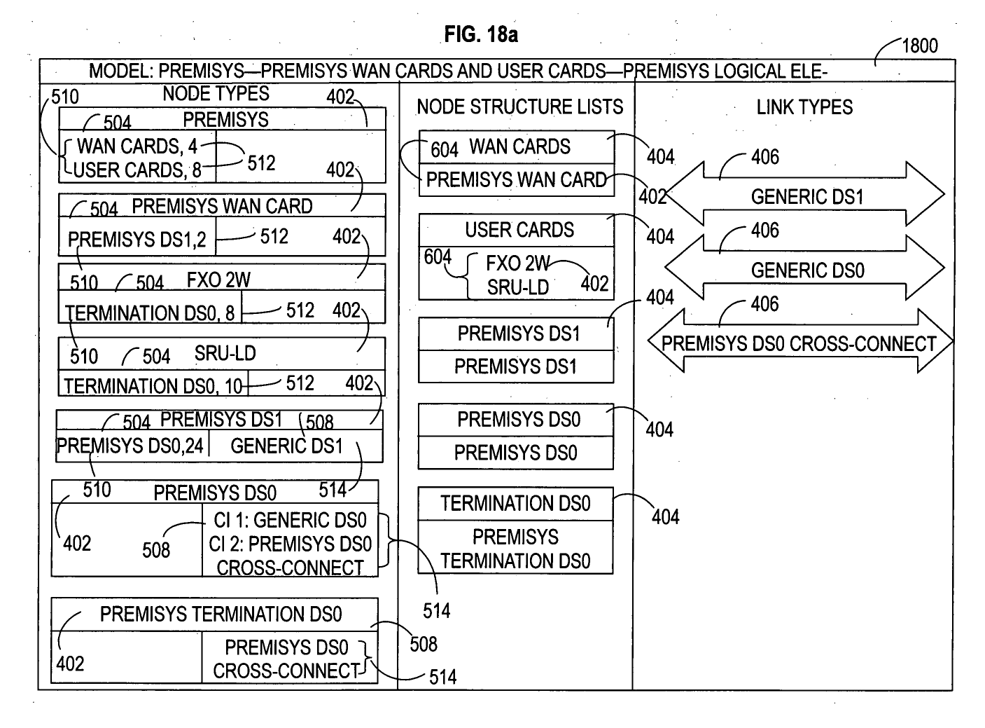

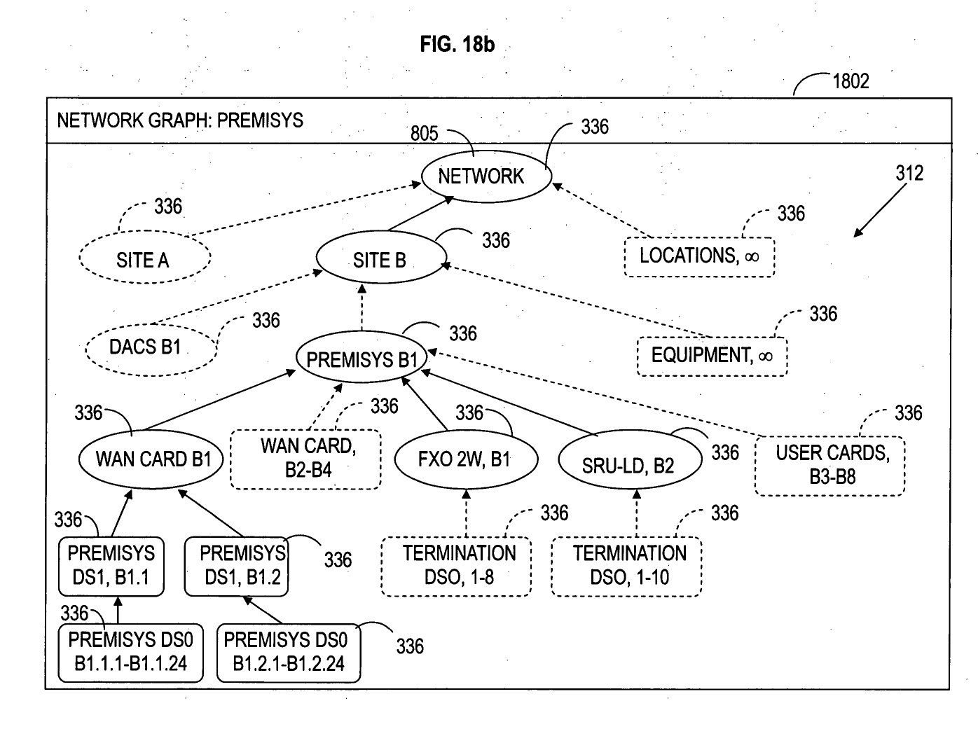

### FIGS. 18a-b

FIGS. 18a-b show a data model 1800 and network graph 312 representing telecommunications network 100 summarizing a Premisys network elements 205 hierarchy 1802 created through the execution of network documentation process 320. Premisys multiplexer 218 is one of network elements 205 that grooms many DS1s, even allowing the constituent DS0s to “drop” out of their containing DS1 connection. The “dropped” DS0s terminate into a wide variety of user cards, which then interface with other the equipment at the geographical location of Premisys multiplexer 218.

Data model 1800 thus includes a “Premisys” node type 402. Structure rules 504 of “Premisys” node type 402 include reference 510 to two of node structure lists 404, i.e., “WAN Cards” node structure list 404 and “User Cards” node structure list 404. For the purpose of this example, unit limit 512 for descendable node types 402 provided in “WAN Cards” node structure list 404 is limited to four. In addition, unit limit 512 for descendable node types 402 provided in “User Cards” node structure list 404 is limited to eight. “WAN Cards” node structure list 404 contains a range of descendable node types 604 that includes only a “Premisys WAN Card” node type 402. However, “User Cards” node structure list 404 contains range of descendable node types 604 that includes an “FXO 2W” node type 402 and an “SRU-LD” node type 402. As is known to those skilled in the art, FXO 2W voice card network element 224 is a voice card that manages the flow of FXO voice traffic through an Integrated Access System, and SRU-LD data card network element 226 is a data card that allows connection of up to ten RS 232 low speed and medium speed data terminals to the Integrated Access System.

Premisys WAN cards 220 are network elements 205 that add grooming capacity to Premisys multiplexer 218, where each of WAN cards 220 bring capacity for two DS1/T1s. Furthermore, User cards 222 are network elements 205 that provide Premisys multiplexer 218 with capacity to “drop” groomed DS0s for any number of communication applications. For the purposes of this example, only FXO 2W voice cards 224 (for Plain Old Telephone System applications) and SRU-LD data card 226 (for serial applications) are modeled.

Data model 1800 thus includes a “Premisys WAN Card” node type 402, an “FXO 2W” node type 402, and an “SRU-LD” node type 402. Structure rules 504 of “Premisys WAN Card” node type 402 include reference 510 to one of node structure lists 404, i.e., “Premisys DS1” node structure list 404. Unit limit 512 for descendable node types 402 provided in “Premisys DS1” node structure list 404 of “Premisys WAN card” node type 402 is limited to two. That is, Premisys WAN card 220 provides two points of connectivity for DS1 network connections 110.

Structure rules 504 of each of “FXO 2W” and “SRU-LD” node types 402 include reference 510 to one of node structure lists 404, i.e., “Termination DS0” node structure list 404. Unit limit 512 for descendable node types 402 provided in “Termination DS0” node structure list 404 for “FXO 2W” node type 402 is limited to eight. That is, FXO 2W voice card 224 provides eight points of capacity to drop DS0s from the groomed DS1s. Unit limit 512 for descendable node types 402 provided in “Termination DS0” node structure list 404 for “SRU-LD” node type 402 is limited to ten. That is, SRU-LD data card 226 provides ten points of capacity to drop DS0s from the groomed DS1s. “Premisys WAN Card” node type 402, “FXO 2W” node type 402, and “SRU-LD” node type 402 do not need to accept connection directly, but instead act as containers for node types 402 that will accept the direct network connections 110.

Within Premisys WAN cards 220 and user cards 222 and 224, other logical structures exist to capture the digital signal multiplexing hierarchy supported by Premisys multiplexer 218. Accordingly, data model 1900 further includes “Premisys DS1” node type 402 that acts as the points of Premisys DS1 connectivity at component/logical layer 204. By definition, each Premisys. DS1 232 is a hierarchy of twenty-four DS0s. A DS1 in this Premisys multiplexer 218 will accept a generic DS1 connection from any piece of equipment at the same geographical location as Premisys multiplexer 218. Consequently, “Premisys DS1” node type 402 includes connectivity rules 508 with reference 514 to “Generic DS1” link type 406.

A Premisys DS0 234 is also a logical network element 205 of Premisys DS1 232, and it is the base bandwidth in the digital hierarchy. In general, a Premisys DS0 230 accepts a generic DS0 connection 110 by definition since its DS1 parent will always accept a generic DS1 connection. A Premisys DS0 230 may also accept a Premisys DS0 cross-connect from another one of nodes 336 defined by “Premisys DS0” node type 402 in Premisys multiplexer 218. Consequently, “Premisys DS0” node type 402 includes connectivity rules 508 with references 514 to “Generic DS0” and “Premisys DS0 Cross-connect” link types 406.

A Termination DS0 236 is a logical network element 205 for user cards, used to “drop” DS0s from groomed DS1 network connections 110. In this example, Termination DS0 236 need only accept a single Premisys DS0 cross-connect from any other logical “DS0” node in Premisys multiplexer 218. Consequently, “Termination DS0” node type 402 includes connectivity rules 508 with reference 514 to “Premisys DS0 Cross-connect” link type 406.

When relating data model 1800 to telecommunications network 100 in Premisys hierarchy 1802, for every Premisys multiplexer 218 at every site 206 in telecommunications network 100, one of nodes 336 defined by “Premisys” node type 402 is created, with the appropriate “Site” node 336 in network graph 312 as parent node 806. Similarly, nodes 336 defined by “WAN Card” and “User Card” node types 402 must be created for every. WAN Card 220 and User Card 222 in each Premisys multiplexer 218 in telecommunications network 100. For every Premisys WAN Card 220 and User Card 222, each subsequent child node 808 must be created because they are not optional.

In summary, the present invention teaches of a computer-based method and a computer program for documenting a network. The computer-based method and computer program models and documents the structure and connectivity of a telecommunications network using a relational database with a fixed schema of data structures that includes node types, node structure lists, and link types. Regardless of the size and variety of the network, the database schema does not change. Rather, the network's diversity is captured utilizing node types, node structure lists, and link types to create a network graph that reflects the network. The fixed schema of data structures allows for straightforward extension of a network model and network documentation to support new communication technologies, interdependencies between network elements, and application specific information. The network documentation technique, yielding the network graph of nodes, links, and circuits, provides network information that is recorded, consolidated, and standardized is a form that can be made readily available throughout an organization.

Although the preferred embodiments of the invention have been illustrated and described in detail, it will be readily apparent to those skilled in the art that various modifications may be made therein without departing from the spirit of the invention or from the scope of the appended claims. For example, the process steps discussed herein can take on great number of variations and can be performed in a differing order then that which was presented.

What is claimed is:

1. A computer-based method for documenting a network comprising:
receiving a configuration of elements within said network;
representing said elements by nodes in a model of said network, each of said nodes being defined by one of a plurality of node types, each of said node types governing structure rules for descendable ones of said nodes; and
presenting said nodes in a network graph in accordance with said structure rules to document said network.

2. A computer-based method as-claimed in claim 1 wherein:
said representing operation comprises:
obtaining a range of said node types descendable from a first one of said nodes in response to said structure rules associated with said first node, said first node representing a first one of said elements in said network; and
creating a child node defined by a first node type within said range of said node types, said child node representing a second one of said elements in said network, said second element being descendent from said first element; and
said presenting operation comprises portraying said child node in said network graph in association with said first node.

3. A computer-based method as claimed in claim 2 wherein said structure rules include a list entry for a node structure list, said node structure list containing said range of said node types, and said obtaining operation comprises accessing said node structure list utilizing said list entry to obtain said range of said node types.

4. A computer-based method as claimed in claim 2 wherein:
said representing operation further comprises creating a second child node defined by said first node type, said second child node representing a third one of said elements in said network, said third element being descendent from said first element; and
said presenting operation further comprises portraying said second child node in said network graph in association with said first node.

5. A computer-based method as claimed in claim 2 wherein:
said representing operation further comprises creating a second child node defined by a second node type within said range of said node types, said second child node representing a third one of said elements in said network, said third element being descendent from said first element; and
said presenting operation further comprises portraying said second child node in said network graph in association with said first node.

6. A computer-based method as claimed in claim 2 further comprising repeating said obtaining, creating, and portraying operations for others of said nodes.

7. A computer-based method as claimed in claim 1 wherein:
a first one of said nodes represents a first one of said elements;
said structure rules for said first node include a unit limit of said descendable ones of said nodes; and
said representing operation comprises creating multiple ones of a child node, a total of said multiple ones of said child node being limited to said unit limit, and said multiple ones of said child node representing multiple elements in said network that are descendent from said first element.

8. A computer-based method as claimed in claim 1 further comprising:
assigning a unique node identifier to said each of said nodes in said network graph; and
correlating said unique node identifier to one of said elements within said network.

9. A computer-based method as claimed in claim 1 wherein said each of said node types further governs connectivity rules for defining links between said nodes, and said method further comprises depicting said links between said nodes in said network graph in accordance with said connectivity rules, each of said links representing connections between two of said elements in said network.

10. A computer-based method as claimed in claim 9 wherein said connectivity rules includes a link entry referencing one of a plurality of link types, each of said link types specifying a type of connection required by said each of said node types, and said depicting operation depicts one of said links between a pair of said nodes when said connectivity rules for said pair of said nodes indicates a common one of said link types.

11. A computer-based method as claimed in claim 9 further comprising:
establishing circuits from said links, said circuits representing continuous paths through said network; and
associating said circuits with ones of said nodes in said network graph.

12. A computer-based method as claimed in claim 11 further comprising:
assigning a unique circuit identifier to each of said circuits in said network graph; and
correlating said unique circuit identifier to a data path within said network.

13. A computer-based method as claimed in claim 1 further comprising:
utilizing a node type template to construct a library of said node types each of which conforms to said node type template, said node type template including a structure rule field for entry of said structure rules; and
selecting one of said node types from said library to define said each of said nodes.

14. A computer-based method as claimed in claim 13 further comprising utilizing a node structure list template to generate a catalog of node structure lists each of which conforms to said node structure list template, said node structure list template including a node type field for entry of said node types for said descendent ones of said node, and said structure rules of said node types referencing said catalog of node structure lists.

15. A computer-based method as claimed in claim 13 wherein said node type template includes a connectivity rule field for entry of connectivity rules specifying a link type for said each node type, and said method further comprises utilizing a link type template to form a list of link types each of which conforms to said link type template and each of which specifies a type of network connection, and said connectivity rules of said node types referencing said list of link types.

16. A computer-based method as claimed in claim 1 wherein said network is a telecommunications network, said nodes in said network graph represent points of interest in said telecommunications network, and said method further comprises utilizing said network graph to manage said telecommunications network.

17. A computer-readable storage medium containing a computer program for documenting a network comprising:
a library of node types constructed in accordance with a node type template, said node type template including a structure rule field for entry of structure rules, said structure rules identifying descendable ones of said node types; and
executable code for instructing a processor to create a network graph, said executable code instructing said processor to perform operations comprising:
receiving a configuration of elements within said network;
representing said elements by nodes in a model of said network, said representing operation comprising:
selecting, a parent node of said nodes, a node type defining said parent node from said library of node types;
obtaining a range of said descendable ones of said node types for said each node in response to said structure rules defining said each node, said each node representing a first one of said elements in said network; and
creating a child node defined by a first node type within said range of said descendable ones of said node types, said child node representing a second one of said elements in said network, said second element being descendent from said first element; and
presenting said child node in association with said each node in a network graph to document said network.

18. A computer-readable storage medium as claimed in claim 17 wherein:
said code further comprises a catalog of node structure lists constructed in accordance with a node structure list template, said node structure list template including a node type field for entry of said node types for said descendable ones of said node types;
said executable code further instructs said processor to reference said catalog of node structure lists in response to said structure rules of said each node type to obtain said range of said descendable node types.

19. A computer-readable storage medium as claimed in claim 17 wherein:
said code further comprises a list of link types constructed in accordance with a link type template, each of said link types specifying a type of network connection;
said node type data structure includes a connectivity rule field for entry of connectivity rules specifying one of said link types for said each node type; and
said executable code further instructs said processor to reference said list in response to said connectivity rules of said each node type to obtain said link type for said node type.

20. A computer-based method for documenting a network comprising:
receiving a configuration of elements within said network;
representing said elements by nodes in a model of said network, each of said nodes being defined by one of a plurality of node types, each of said node types governing structure rules for descendent ones of said nodes and connectivity rules for defining links between said nodes, said representing operation including:
obtaining a range of said node types descendable from a first one of said nodes in response to said structure rules associated with said first node, said first node representing a first one of said elements in said network; and
creating a child node defined by a first node type within said range of said node types, said child node representing a second one of said elements in said network, said second element being descendent from said first element;
presenting said nodes in a network graph in accordance with said structure rules to document said network, said child node being portrayed in association with said first node; and
depicting said links between said nodes in said network graph in accordance with said connectivity rules, each of said links representing connections between two of said elements in said network.

21. A computer-based method as claimed in claim 20 wherein:
said representing operation further comprises creating a second child node defined by said first node type, said second child node representing a third one of said elements in said network, said third element being descendent from said first element; and
said presenting operation further comprises portraying said second child node in said network graph in association with said first node.

22. A computer-based method as claimed in claim 20 wherein:
said representing operation further comprises creating a second child node defined by a second node type within said range of said node types, said second child node representing a third one of said elements in said network, said third element being descendent from said first element; and
said presenting operation further comprises portraying said second child node in said network graph in association with said first node.

23. A computer-based method as claimed in claim 20 wherein said structure rules include a unit limit of said child node defined by said first node type, and said creating operation comprises creating multiple ones of said child node defined by said first node type, a total of said multiple ones of said child node being limited to said unit limit, and said multiple ones of said child node representing multiple elements in said network that are descendent from said first element.

24. A computer-based method as claimed in claim 20 wherein said connectivity rules reference one of a plurality of link types, each of said link types specifying a type of connection required by said each of said node types, and said depicting operation depicts one of said links between a pair of said nodes when said connectivity rules for said pair of said nodes indicates a common one of said link types.

25. A computer-based method as claimed in claim 20 further comprising:
establishing circuits from said links, said circuits representing continuous paths through said network; and
associating said circuits with ones of said nodes in said network graph.
